(19) United States
(12) Patent Application Publication
(10) Pub. No.: US 2024/0203180 A1
(43) Pub. Date: Jun. 20, 2024

(54) METHOD FOR EFFECTING AN ELECTRONIC OPENING CONTROL

(71) Applicant: TECH4MED LIFE SCIENCE GMBH, Darmstadt (DE)

(72) Inventor: Nico Höler, Frankfurt am Main (DE)

(73) Assignee: TEC4MED LIFE SCIENCE GMBH, Darmstadt (DE)

(21) Appl. No.: 18/568,544

(22) PCT Filed: Jun. 9, 2022
(86) PCT No.: PCT/EP2022/065752

§ 371 Date: Dec. 8, 2023

(30) Foreign Application Priority Data
Jun. 9, 2021 (LU) LU500264

(51) Int. Cl. G07C 9/00

(52) U.S. Cl. CPC G07C 9/00309; G07C 9/00912; G07C 2009/00769; G07C 2009/0092

(57) ABSTRACT

The invention relates to a method for controlling a closure device (1) and to a closure device (1) for closing and opening a container (2) for receiving goods (10). In a state monitoring operation (3), at least one state measurement affecting the interior of the container (2) is detected by means of at least one state sensor (4). Opening requirements for moving the closure device (1) from a closed position to an open position in order to open the container (2) are checked in an opening request operation (6). The opening request operation (6) comprises an authentication step (7) and a state check step (9). The validity of an authentication key stored on at least one authentication means (8) is checked in the authentication step (7). In the state checking step (9), the at least one state measurement or at least one state calculation value determined from the at least one state measurement is compared with a defined range of state values assigned to the state sensor. The closure device (1) is moved into the open position and the container (2) is opened to re-lease the goods (10) if the at least one state measurement is within the respective defined range of state values and the validity of the authentication key is confirmed.

The invention relates to a method for controlling a closure device and to the closure device for closing and opening a container for receiving goods.

For example, transport containers for receiving transported goods are known from the state of the art. The transport container can for example be a refrigeration box for transporting medications, a transport box for transporting a payload, or a container for transporting foodstuffs. In addition to transport containers, stationary containers such as refrigerators for storing medications are also known. The container types described above are hereinafter referred to as containers. The term goods refers to transported goods, such as discrete goods or bulk goods, which are subjected to a spatial change in location, but also to stored goods stored tinder controlled or uncontrolled conditions at a location, without a spatial change in location.

In order to monitor goods to be transported during the transport operation or during loading, as well as goods during storage in the stationary container, sensors are known by which the environmental conditions affecting the goods can be monitored and recorded.

These sensors can for example be accelerometers, temperature or humidity sensors to record accelerations caused by vibrations or shocks or influences of temperature, humidity or brightness on the monitored goods.

The state sensors are for example arranged within the containers, near the goods to be transported or stored such that the environmental conditions can be recorded in the immediate vicinity of the goods. The state measurements detected during transport, during loading or during storage are generally recorded in a memory, and are read and evaluated after transport of the goods or at regular intervals. The state measurements are transmitted between the state sensors and a central memory unit, for example by means of NFC or Bluetooth Low Energy (BLE).

Containers known from the prior art can be closed by means of a locking device during transport and during stationary storage and can be opened by entering an access code. Thus, any unauthorized removal of a transported goods is to be prevented during transport or storage. In addition to access codes on chip cards, known means of authentication also include fingerprints or facial recognition.

Monitoring systems for containers are also known, by means of which, for example, opening of the container during a transport operation can be controlled. For this purpose, a unique digital seal is generated when the container is closed, which is then stored in a memory of the monitoring system. The digital seal regenerates itself during each subsequent closure operation such that the digital seal can be uniquely mapped to a closure operation. Thus, after the transport operation, it is traceable whether a potentially unauthorized opening of the container has taken place. Regardless of this, opening the container can lead to a change in environmental conditions within the container that are potentially harmful for the goods. However, any unauthorized opening of the container can only be detected after the fact such that the opening and the changing environmental conditions can only be detected too late and only after a transport operation. A check of the unauthorized opening of a stationary container for the removal of goods can then also be checked.

The object of the present invention is to provide a method for the traceability of state-dependent authorization-controlled logging and opening of a container.

According to the invention, this task is solved by a method w % herein at least one measurement affecting the interior of the container is detected in a state monitoring operation by means of at least one state sensor, wherein the opening requirements for moving the closure device from a closed position to an open position in order to open the container are checked in an opening request operation, wherein the opening request operation comprises an authentication step and a state checking step, wherein the validity of an authentication key stored on at least one authentication means is checked in the authentication step, wherein the at least one state measurement or at least one state calculation value determined from the at least one state measurement is compared with a defined range of state values assigned to the state sensor in the state checking step, wherein the closure device is moved into the open position and the container is opened to release the goods if the at least one state measurement is within the respective defined range of state values and the validity of the authentication key is confirmed.

In order to transport the goods to be protected in containers, it is desired that only a certain group of persons are given access to the goods located in the container during or after transport of the container. The method according to the invention optionally specifies that the closure device comprises a locking device, such as a lock, by which an access door of the container is closed and kept closed until a user uses a corresponding and valid authentication key to open the door of the container. Different groups of people can be assigned different authorizations to actuate the locking device. For this purpose, the group of persons consisting of the sender and the recipient of the container can have opening authorizations, whereas persons who, for example, carry out the transport of the container, are not given opening authorizations.

As a further limiting condition for opening the container, in particular for goods sensitive to shock or temperature, such as drugs, active ingredients, or even human organs or foodstuffs, it is important to avoid opening the container during transport. For this purpose, the door of the container remains closed such that the ambient conditions prevailing inside the container, such as temperature, humidity or brightness, can be maintained within defined limits. However, the in invention also specifies that the state measurements affecting the interior are recorded with the state sensor in order to detect environmental conditions prevailing outside the container. An outside temperature, an outside relative humidity or accelerations affecting the container, such as shocks, are detected by the state sensor, since these affect the goods located within the interior the container in an unopened state as well as in an opened state of the container.

It is also possible and specified by the invention that an opening request operation by a recipient with a valid means of authentication for opening the container is rejected if at least one of the state measurements is or was outside the corresponding defined state measurement range during transport. An opening request operation is rejected accordingly. In this manner, it can be avoided that, for example, drugs or foodstuffs whose transport must comply with a defined temperature, are used despite exceeding this temperature. However, it is also possible and specified by the invention that a recipient with opening authorization can open the container even if one of the state measurements is outside the corresponding defined state measurement range. This makes it possible to remove or check the goods stored or transported in the container at any time.

An advantageous implementation of the idea of the invention provides that a state value range is defined for each state sensor. Environmental conditions of various goods arranged in different areas of the container can then be detected by state sensors arranged in the immediate vicinity of the goods. Various state sensors, such as temperature sensors, humidity sensors or brightness sensors, can be used. However, state measurements of different physical metrics determined by means of a state sensor can also be divided into predefinable state value ranges.

A particularly electricity- and energy-saving execution of the method according to the invention specifies in an advantageous implementation of the inventive idea that the state monitoring operation is initiated at a predetermined point in time or by a predetermined initiation event. Instead of continuously recording the state measurements, the state measurements can for example be acquired at defined time intervals or at specific times. During the remaining time intervals, the state sensor is advantageously in an inactive or energy-saving sleep state. The invention also specifies that the state monitoring operation is initiated by a manual or remote-controlled actuation of the closure device.

For a permanent and thus power supply-independent storage of the state measurements, an advantageous embodiment of the invention specifies that the state measurements are stored in a memory unit of the closure device or in a memory unit of the at least one state sensor. By storing the state measurements in a non-volatile memory unit, a subsequent evaluation of the state measurements or the calculation of a state calculation value is possible. By the predefinable points in time and by a predefinable initiation event, the state measurements can be stored in the memory unit in a particularly memory-efficient manner in comparison to recording and storing the state measurements continuously.

The invention also specifies that the closure device does not provide a locking mechanism for the door of the container. Rather, an opening operation and a closing operation are detected and stored in the memory unit, in addition to the state measurements.

A particularly memory-saving implementation of the method according to the invention specifies that only those state measurements lying outside of the state value range assigned to the state measurement are stored in the memory unit of the state sensor or in the memory unit of the closure device. Since it can therefore be assumed that there are no environmental conditions that damage the goods, the state measurements within the range of the state value range can be disregarded and are not stored, thus allowing the method to be carried out in a very memory-saving manner.

The invention also optionally specifies that the state measurements are detected and stored continuously and completely. This involves recording state measurements within and outside the state value range. A particularly good traceability of the past transport path or the closure duration is thus possible, therefore allowing the container to be opened in a particularly safe state.

An advantageous embodiment of the idea of the invention specifies that the state calculation value calculated from one or more different state measurements can be used to determine a timeline of the recorded and the expected state measurements. A timeline can for example be determined as a trend of a time series formed by the state measurements. According to the invention, it can also be provided that an opening request operation is rejected if state measurements lie outside the state value range several times in consecutive intervals. Thus, a particularly secure storage of particularly sensitive goods within the container is possible.

Likewise, an opening request operation by a recipient with a valid means of authentication for opening the container is advantageously and inventively rejected if it is expected that the state measurements will directly exceed or fall below the state measurements specified within the defined state measurement range when the container is opened. For this purpose, an advantageous embodiment of the method according to the invention specifies that environmental conditions present outside the container are also taken into account for calculating the state calculation value. This can for example be achieved by arranging at least one state sensor outside the container. An opening control controlled in this manner protects the goods transported or stored in the container particularly well against environmental influences.

A particularly simple implementation of the authentication step specifies in an advantageous implementation of the inventive idea that an authorization code is used as an authentication key, wherein the authorization code is entered using an input device of the closure device. Thus, the container can be opened by any user who knows the authorization code. On the other hand, access authorization provided by an authorization code presents the risk that an unauthorized group of persons gains access to the authorization code and thus to the contents of the container. It is also possible and specified by the invention to enter the authorization code using an input device connected wirelessly to the closure device.

For increased security against the unauthorized opening of the container, it is provided in an advantageous embodiment of the invention that the authentication key is transmitted by a near-field communication device by means of BLE, RFID. GSM or WLAN. Authentication for example requires a chip card or a Bluetooth-enabled terminal dev ice, such as a cellphone. Thus, the container can only be opened with a physically present means of authentication. The authentication key is advantageously formed from a combination of an authorization code and an authentication key provided by means of a near field communication device. The unauthorized opening of the container can thus be prevented particularly securely.

In order for a user to be able to open or close the container independently of the presence of a physical means of authentication, an advantageous embodiment of the inventive idea specifies that the authentication key is transmitted by a telecommunications device, in particular over a mobile network or over a WLAN. Opening the container or issuing the opening authorization is thus controllable from a remote location from a service provider network, such as a cloud. Due to the location-independent application, such an embodiment of the invention is advantageously usable, in particularly when using transport containers. Moreover, the container can thus only be opened by combining the physical means of authentication, such as a mobile phone, and an authorization code, or other means of authentication, such as a fingerprint entered using the mobile phone.

An advantageous implementation of the inventive idea specifies that the recorded state measurements are transmitted between the at least one state sensor and the closure device by means of BLE, RFID, GSM or WLAN. A wireless transmission of the state measurements is thus possible. The state sensor can thus be arranged particularly advantageously within the container in the immediate vicinity of the goods such that the environmental conditions or the state measurements are recorded particularly precisely.

An advantageous implementation of the inventive idea specifies that the state measurements transmitted to the closure device can be transmitted between the closure device and a service provider network by means of an LTE modem, a mobile phone modem, or by means of WLAN. A transmission of the state measurements stored on the memory unit could then be stored on a server existing within the service provider network, and memory space could then be released on the memory unit. The freed-up memory space of the closure device can thus be used again to store state measurements. This prevents reaching the maximum storage capacity of the memory unit of the closure device.

The task specified above is also achieved by a closure device for closing a container suitable for receiving goods, wherein the closure device comprises at least one state sensor for determining state measurements affecting an interior of the container, wherein the closure device comprises an authentication device, by means of which an opening of the closure device can be controlled, wherein a locking device can be moved from a closed position to an open position such that the container is opened and the goods are released. The invention optionally specifies that the closure device comprises a locking device by which an access door of the container is closed and kept closed. Such a locking device can for example be adapted as a lock. The lock is advantageously adapted as a solenoid lock, as a mechatronic lock or as a wireless lock such that the lock can be controlled and actuated remotely, and can also be actuated with a key. To determine the state measurements within the container and preferably in the immediate vicinity of the goods, it is possible according to the invention to arrange the state sensor within the container. The environmental conditions prevailing within the container and affecting the goods can then be recorded particularly precisely.

In order to record the environmental conditions prevailing outside the container by determining the state measurements affecting the interior of the container, an advantageous embodiment of the invention specifies that the state sensor is arranged on an outer side of a housing wall of the container. For example, the state sensor can be fixed to the housing wall of the container with fastening elements, such as screws, cable ties, tensioning straps or hook & loop fasteners. The state measurements can then be recorded in the immediate vicinity of the container such that the recorded state measurements correspond particularly precisely to the state measurements affecting the interior of the container.

An advantageous embodiment of the invention specifies that the state sensor comprises at least one measuring probe arranged within the interior of the container. The measuring probe can for example be guided through the housing wall of the container with a wire fed through a feed-through opening. Alternatively, a wireless connection between the at least one measuring probe and the state sensor is possible. In particular for larger containers, such as shipping containers, a measuring probe arranged in different areas of the shipping container is advantageous in order to accurately record various state measurements at different positions near the goods. It is therefore possible and specified by the invention that the state sensor is arranged on an outer side of the housing wall of the container in order to receive, for example, GNSS signals or mobile communications signals, without interference, and also to record other state measurements relating to the environmental conditions of the container. It is also possible and specified by the invention that further measuring probes are arranged on the housing wall outside the container such that environmental conditions can be recorded in different outer areas of the container.

Depending on the type of goods being transported in the container, it can be appropriate to monitor various state measurements during transport or storage of the goods. An advantageous implementation of the invention idea specifies that the state sensor is adapted as an accelerometer, gyroscope. GNSS sensor, mobile communications receiver, temperature sensor, pressure sensor, C02 sensor or humidity sensor. Global satellite systems such as GPS, GLONASS, Galileo or Beidou are combined under GNSS sensors (global navigation satellite system). The container position can also be determined by mobile triangulation or by evaluating WLAN connections. The invention can optionally also specify that the state sensors can be placed into an energy-saving sleep mode. It can also advantageously be provided according to the invention that the state measurements are only recorded when the state value range defined for each state sensor is left.

According to the invention, it is optionally provided that a defined position location of the container also serves as an opening requirement, in addition to or as an alternative to the environmental conditions. This involves specifying a so-called geo-fencing zone, which is a region or a position location wherein the opening of the container is permitted or specifically not permitted. The current position location of the container is determined using the GNSS sensors described above or using a mobile phone localization method.

According to the invention, the state sensors each have their own memory unit that stores the state measurements. The state values are recorded and stored separately and independently of each other on each state sensor. In order to release any occupied memory space on the state sensor at regular intervals, an advantageous embodiment of the invention specifies that the closure device comprises a transceiver unit that can transmit the state measurements determined by the at least one state sensor to the closure device.

In order to allow the memory space on the memory unit of the closure device to be released, an advantageous embodiment of the inventive closure device specifies that the closure device comprises a transmission module, by means of which the state measurements can be transferred to a service provider network. The data transmission of the state values stored in the memory unit of the closure device can for example be started as soon as a mobile connection between the transmission module and the service provider network can be established. In local regions and time intervals in which a connection to the service provider network cannot be established, the state measurements continue to be stored temporarily in the memory unit of the closure device.

According to the invention, it is advantageously optionally provided that state measurements are only stored in the memory unit of the state sensor or the closure device if a state measurement lies outside the state value range assigned to the state measurement.

The task defined above is also achieved by a method for initializing a closure device, wherein authentication information defined by an initialization operation for the authentication operation is transmitted and stored in the memory unit of the closure device, wherein the state monitoring operation is started after the closure device is closed. The authorization information and authentication information necessary for operating the closure device can be stored during the initialization operation. In particular, a user with extensive rights must be defined who can determine and assign additional personnel groups and state measurement ranges for opening the container.

In order for the closure device to be initialized particularly easily and independently of location, an advantageous implementation of the inventive idea specifies that the authentication information is transmitted using a telecommunications device, in particular over a mobile network or over a WLAN. Thus, the initialization operation can also be carried out without the direct presence of a user, but centrally or cloud-based over a service provider network.

Further advantageous embodiments of the idea of the invention are explained with reference to the exemplary embodiments shown in the drawings. The following is shown in the Figures:

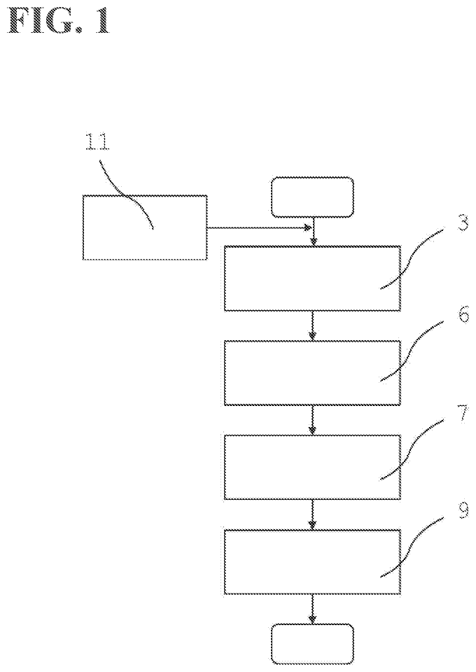

FIG. 1 a schematic illustration of the method according to the invention for controlling a closure device in the form of a flowchart, and

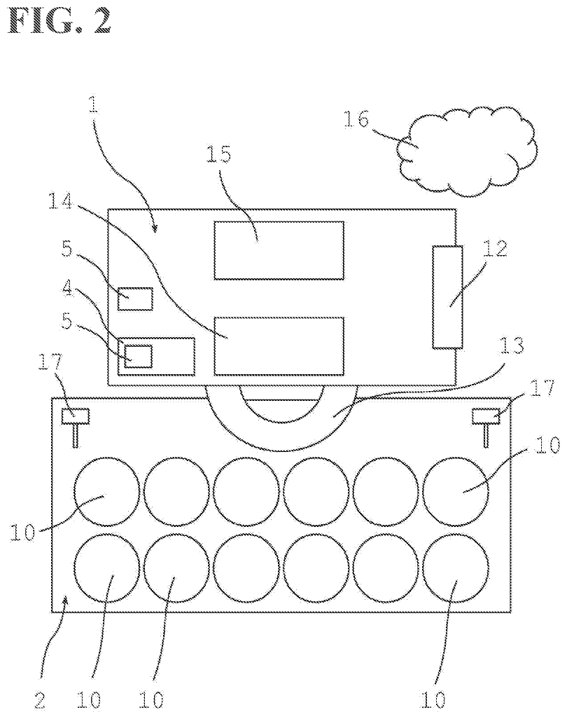

FIG. 2 a schematic illustration of the inventive closure device.

FIG. 1 shows a schematic illustration of the method according to the invention for controlling an inventive closure device for closing and opening a container in the form of a flow diagram. By means of at least one state sensor arranged inside or outside the container, a state monitoring operation 3 continuously records state measurements and stores the latter in a memory unit of the closure device. In an opening request operation 6, opening requirements for moving the locking device from a closed position to an open position for opening the container are checked. An authentication step 7 checks a validity of an authentication key stored on at least one means of authentication.

A subsequent state checking step 9 compares the state measurements acquired and recorded during the state monitoring operation 3 to defined state value ranges. The closure device is moved to the open position and the container is opened when the state measurements are within the defined state value ranges and the validity of the authentication key was confirmed. An initialization operation 11 preceding the described method transmits and stores the authentication information defined for the authentication operation in the memory unit of the closure device. After the closure device is closed, the state monitoring operation is started, wherein the state measurements are recorded at defined intervals. The initialization operation 11 stores the authorization information and authentication information required for operating and controlling the closure device in the memory unit.

FIG. 2 shows a schematic illustration of the inventive closure device 1 for closing a container 2 suitable for receiving goods 10. The closure device 1 comprises a state sensor 4 with two measuring probes 17 arranged within the container 2 for determining state measurements. The data transfer between the measuring probes 17 and the state sensor 4 is carried out wirelessly using Bluetooth. An opening of the closure device 1 can be controlled by means of an authentication device 12 of the closure device 1.

A locking device 13 can be moved from a closed position to an open position such that the container 2 is opened and the goods 10 are released. The closure device 1 comprises a transceiver unit 14, by means of which the state measurements recorded by the at least one state sensor 4 can be transmitted to the closure device 1. The state measurements recorded with the measuring probe 17 within the container 2 are transmitted to the state sensor 4 and are stored temporarily in the memory unit 5 of the state sensor 5. The state measurements stored in the memory unit 5 of the state sensor 5 are then transmitted to the memory unit 5 of the closure device 1. The state measurements are transmitted to a service provider network 16 by means of a transmission module 15 of the closure device 1.

1-20. (canceled)

21. A method for controlling a closure device for closing and opening a container for receiving goods, the method comprising:
detecting in one condition monitoring process, by at least one condition sensor, a time course of a plurality of condition measurement values acting on an interior of the container;
checking, in an opening request process, opening requirements for a transfer of the closure device from a closed position to an open position for opening of the container,
wherein the opening request process has an authentication step and a status checking step;
checking, in the authentication step, the validity of an authentication key stored on at least one authentication means,
comparing, in the condition testing step, (i) the time course of the plurality of condition measurement values recorded during the condition monitoring process or at least one condition calculation value determined from the time course of the plurality of condition measurement values with (ii) a predetermined condition value range assigned to the condition sensor;
moving, the closure device into the open position to enable the container to be opened to release the goods, if (a) the time course of the plurality of condition measurement values is within a respective, predetermined status value range and (b) the validity of the authentication key is confirmed.

22. The method according to claim 21, wherein the at least one authentication means comprises a remotely-disposed computer providing the authentication key via a network connection to remotely instruct transfer of the closure device from the closed position to the open position.

23. The method according to claim 22, wherein the remotely-disposed computer provides the authentication key automatically.

24. The method according to claim 21,
wherein the condition sensor comprises an acceleration sensor, and
wherein the condition measurement values comprise measured vibrations or measured shocks measured by the acceleration sensor.

25. The method according to claim 21, wherein the condition sensor comprises a sensor that measures a tilt of the container.

26. The method according to claim 21, wherein the condition sensor is at least one of an acceleration sensor, gyroscope, global navigation satellite system (GNSS) sensor, mobile radio receiver, temperature sensor, light, pressure sensor, carbon dioxide sensor, or humidity sensor.

27. The method according to claim 21, wherein a status value range is defined for the condition sensor.

28. The method according to claim 21, wherein the condition monitoring process is triggered at a predeterminable time or by a predeterminable trigger event.

29. The method according to claim 21, wherein the condition measurement values determined by the condition sensor are stored as stored condition measurement values on a storage unit of the closure device or on a storage unit of the condition sensor.

30. The method according to claim 27, wherein only the condition measurement values lying outside the status value range associated with the condition measurement value are stored on a storage unit of the condition sensor or on a storage unit of the closure device.

31. The method according to claim 21,
wherein an authorization code is used as the authentication key,
wherein the authorization code is remotely transmitted via the internal mobile network communication unit to the closure device.

32. The method according to claim 31, wherein the authentication key is transmitted via a near-field communication device using BLE, RFID, or WLAN.

33. The method according to claim 31, wherein the authentication key is transmitted by a telecommunications device via a mobile radio network or via a WLAN.

34. The method according to claim 21, wherein the condition measurement values are transmitted between the at least one condition sensor and the closure device by BLE, RFID, LPWAN, LORWAN, WLAN, or a cable.

35. The method according to claim 29, wherein the stored condition measurement values are transferred to a service provider network by at least one of (i) a cellular modem, (ii) a mobile radio modem, and (iii) WLAN.

36. The method according to claim 21, wherein the condition sensor is a component of the closure device.

37. The method according to claim 21, wherein the condition sensor is physically separate from and electronically to the closure device.

38. A closure device for closing a container suitable for holding goods, the closure device having:
at least one status sensor for determining condition measurement values acting on an interior of the container; and
an authentication device configured to control opening of the closure device,
wherein a locking device can be moved from a closed position to an open position, so that the container is opened and the goods are released,
wherein the authentication device comprises a telecommunication device connected to a remotely-disposed computer providing an authentication key via a network connection to remotely instruct moving of the locking device from the closed position to the open position.

39. The closure device according to claim 38,
wherein the condition sensor comprises an acceleration sensor, and
wherein the condition measurement values comprise measured vibrations or measured shocks measured by the acceleration sensor.

40. The closure device according to claim 38, wherein the condition measurement values comprise measured tilt of the container.

41. The closure device according to claim 38, wherein the condition sensor is on a housing wall of the container.

42. The closure device according to claim 38, wherein the condition sensor has at least one measuring probe arranged in an interior of the container.

43. The closure device according to claim 38, wherein the condition sensor is at least one of an acceleration sensor, a gyroscope, a global navigation satellite system (GNSS) sensor, a mobile radio receiver, a temperature sensor, a light sensor, a pressure sensor, a CO2 sensor, or a humidity sensor.

44. The closure device according to claim 38, wherein the closure device has a transceiver unit with which the condition measurement values determined by the at least one condition sensor can be transferred to the closure device.

45. The closure device according to claim 38, wherein the closure device has a transmission module with which the condition measurement values can be transmitted to a service provider network.
